(19) United States
(12) Patent Application Publication
(10) Pub. No.: US 2024/0347262 A1
(43) Pub. Date: Oct. 17, 2024

(54) COUPLED INDUCTOR

(71) Applicant: CYNTEC CO., LTD., Hsinchu (TW)

(72) Inventors: Po-Kai Lai, Hsinchu (TW); Cheng-Fan Lee, Hsinchu (TW)

(73) Assignee: CYNTEC CO., LTD., Hsinchu (TW)

(21) Appl. No.: 18/416,833

(22) Filed: Jan. 18, 2024

Related U.S. Application Data
(60) Provisional application No. 63/459,697, filed on Apr. 16, 2023.

(51) Int. Cl. H01F 27/30; H01F 27/255

(52) U.S. Cl. CPC H01F 27/306; H01F 27/255

(57) ABSTRACT

A coupled inductor including a first coil wound around a first pillar, a second coil wound around a second pillar, a gap magnetic body between the first coil and second coil and comprised of magnetic powders, a first magnetic body on the first coil opposite to the gap magnetic body, and a second magnetic body on the second coil opposite to the gap magnetic body, wherein the first magnetic body, first coil, gap magnetic body, second coil and second magnetic body are stacked sequentially in a first direction, and a ratio of a thickness of the gap magnetic body in the first direction to mean particle size D90 of the magnetic powders in gap magnetic body is between 2-30 or between 0-0.75.

### CROSS REFERENCE TO RELATED APPLICATIONS

This application claims the benefit of U.S. Provisional Application No. 63/459,697, filed on Apr. 16, 2023. The content of the application is incorporated herein by reference.

### BACKGROUND OF THE INVENTION

### 1. Field of the Invention

The present disclosure relates generally to a coupled inductor, and more specifically, to a coupled inductor with gap magnetic body for controlling coupling coefficient.

### 2. Description of the Related Art

In conventional skill, a coupled inductor is generally provided with two central pillars stacked in vertical direction for purposes of fixing internal components and providing path for magnetic flux, wherein each pillar is wounded or surrounded by a coil that may generate induced electromotive force through mutual electromagnetic induction. Since the dimension of gap between the two coils determines the coupling coefficient of coupled inductor, in order to control the coupling coefficient and achieve better inductive performance, a gap magnetic body will be set designedly between the two coils for fixing the distance between the two coils, such as in a form of magnetic sheet or magnetic glue.

In current process of manufacturing coupled inductor, the coil windings and metal magnetic powder are usually hot-pressed together in a mold to form the aforementioned gap magnetic body and the upper and lower magnetic bodies (may also be referred as magnetic cores) that enclose the entire coil structure. However, in actual implementation, it is difficult to form a gap magnetic body with precise dimension between the coils in the center of molds, especially through hot-pressing and sintering process. The gap magnetic body formed after hot-pressing usually suffer more or less deformation, resulting in wide distribution and large deviation of the coupling coefficient k from the target value in final product, unable to meet strict precision requirement in 5G wireless system and automotive electronics application. Furthermore, high tension induced by copper lines of the coil windings in hot-pressing process may easily break the pillars that use to fix the coil windings, thereby further impacting the performance of coupling coefficient k of final inductor product. Therefore, those of skill in the art need to develop a better solution for the aforementioned issues.

### SUMMARY OF THE INVENTION

In the light of the aforementioned problems encountered in conventional skill, the present disclosure hereby provides a coupled inductor with particular dimensional specification, characterized by using magnetic powder with specific mean particle size to form the gap magnetic body of coupled inductor, so that the deviation of gap dimension and the resulting coupling coefficient k may be effectively minimized.

One aspect of the present disclosure is to provide a coupled inductor, including a first coil wound around a first pillar, a second coil wound around a second pillar, a gap magnetic body between the first coil and second coil and comprised of magnetic powders, a first magnetic body on the first coil opposite to the gap magnetic body, and a second magnetic body on the second coil opposite to the gap magnetic body, wherein the first magnetic body, the first coil, the gap magnetic body, the second coil and the second magnetic body are stacked sequentially in a first direction, and a ratio of a thickness of the gap magnetic body in the first direction to mean particle size D90 of the magnetic powders in the gap magnetic body is between 2-30 or between 0-0.75.

Another aspect of the present disclosure is to provide a coupled inductor, including a first coil wound around a first pillar, a second coil wound around a second pillar, a gap magnetic body between the first coil and second coil and comprised of magnetic powders, a first magnetic body on the first coil opposite to the gap magnetic body, and a second magnetic body on the second coil opposite to the gap magnetic body, wherein the first magnetic body, the first coil, the gap magnetic body, the second coil and the second magnetic body are stacked sequentially in a first direction, and the gap magnetic body overlaps the first coil and the first pillar and overlaps the second coil and the second pillar in the first direction of first coil and second coil, and a ratio of an area of the gap magnetic body in the first direction to an area of the first magnetic body is between 60%-85%.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view of a coupled inductor in accordance with an embodiment of the present disclosure;

FIG. 2 is a schematic isometric view of a coupled inductor in accordance with an embodiment of the present disclosure;

FIG. 3 is a schematic cross-sectional view illustrating examples of coupled inductors with different ratios of the thickness of gap magnetic body to mean particle size in the gap magnetic body;

FIG. 4 is a schematic plan view illustrating the coil and the gap magnetic body of coupled inductor in accordance with an embodiment of the present disclosure;

FIG. 5 is a schematic cross-sectional view illustrating examples of coupled inductor with different thickness ratios of the coil to gap magnetic body;

FIG. 6 is a schematic cross-sectional view illustrating examples of coupled inductors with different width-to-thickness ratios of the coil; and

FIG. 7 is a schematic cross-sectional view of coupled inductor illustrating the upper magnetic body and lower magnetic body having different thicknesses.

Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

Reference will now be made in detail to exemplary embodiments of the invention, which are illustrated in the accompanying drawings in order to understand and implement the present disclosure and to realize the technical effect. It can be understood that the following description has been made only by way of example, but not to limit present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

It should be readily understood that the meaning of “on,” “above,” and “over” in the present disclosure should be interpreted in the broadest manner such that “on” not only means “directly on” something but also includes the meaning of “on” something with an intermediate feature or a layer therebetween, and that “above” or “over” not only means the meaning of “above” or “over” something but can also include the meaning it is “above” or “over” something with no intermediate feature or layer therebetween (i.e., directly on something). Further, spatially relative terms, such as “beneath,” “below,” “lower,” “above,” “upper,” and the like, may be used herein for ease of description to describe one element or feature relationship to another element(s) or feature(s) as illustrated in the figures.

As used herein, the term “layer” refers to a material portion including a region with a thickness. A layer can extend over the entirety of an underlying or overlying structure, or may have an extent less than the extent of an underlying or overlying structure. Further, a layer can be a region of a homogeneous or inhomogeneous continuous structure that has a thickness less than the thickness of the continuous structure. For example, a layer can be located between any pair of horizontal planes between, or at, a top surface and a bottom surface of the continuous structure. A layer can extend horizontally, vertically, and/or along a tapered surface. A substrate can be a layer, can include one or more layers therein, and/or can have one or more layer thereupon, thereabove, and/or therebelow. A layer can include multiple layers. For example, an interconnect layer can include one or more conductor and contact layers (in which contacts, interconnect lines, and/or through holes are formed) and one or more dielectric layers.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. Additionally, the term “based on” may be understood as not necessarily intended to convey an exclusive set of factors, but may allow for the presence of other factors not necessarily expressly described, again depending at least in part on the context.

It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

First, please refer to FIG. 1, which is a schematic cross-sectional view of a coupled inductor in accordance with an embodiment of the present disclosure. In the embodiment, the coupled inductor 100 may include a first coil 106 and a second coil 108. The first coil 106 and second coil 108 may include a conductive wire with at least one winding turn, for example, a copper wire. The first coil 106 and second coil 108 may be wound or set respectively around a first pillar 102b and a second pillar 104b. The first pillar 102b may be a part of an upper magnetic body 102, which may include a base part 102a, the first pillar 102b and sidewall part 102c. The first pillar 102b may extend in a vertical direction D1 from the center of base part 102a. The sidewall parts 102c may extend in the vertical direction D1 from the periphery of base part 102a. The second pillar 104b may be a part of a lower magnetic body 104, which may include a base part 104a and the second pillar 104b. The second pillar 104b may extend in the vertical direction D1 from the center of base part 104a. A recess 105 may be formed on the bottom or an outer surface of base part 104a in the vertical direction D1 to separate the bottom of lower magnetic body 104 into two contact regions. After assembly, the upper magnetic body 102 and the lower magnetic body 104 may form collectively an internal space for accommodating components inside the coupled inductor 100. In other embodiment, the lower magnetic body 104 may also have peripheral sidewall parts to match the sidewall parts 102c of the upper magnetic body 102. In still another embodiment, the first pillar 102b or second pillar 104b may be a separate part from the upper magnetic body 102 or lower magnetic body 104, which may be mounted on the base part 102a or base part 104a after assembly to fix the first coil 106 and second coil 108 and provide a path for magnetic flux.

Refer still to FIG. 1. After assembly or hot-pressing, the first coil 106 and the second coil 108 may be enclosed and fitted in the internal space formed by the upper magnetic body 102 and lower magnetic body 104. In the embodiment of the present disclosure, a gap magnetic body 110 may be designedly set between the first coil 106 and the second coil 108 for fixing the height of the two coils, so as to obtain predetermined coupling coefficient K required by the coupled inductor 100. The first coil 106 and the second coil 108 are opposite to each other through the gap magnetic body 110 in the vertical direction D1, and the base part 102a of upper magnetic body 102 is opposite to the gap magnetic body 110 through the first coil 106 and the first pillar 102b in the vertical direction D1. The base part 104a of lower magnetic body 104 is opposite to the gap magnetic body 110 through the second coil 108 and the second pillar 104b in the vertical direction D1. In the present disclosure, the lower magnetic body 104, the second coil 108, the gap magnetic body 110, the first coil 106 and the upper first magnetic body 102 are stacked sequentially in the vertical direction D1, constituting a compact, closed coupled inductor 100. In addition, parts of the first coil 106 and second coil 108 may extend to the bottom of base part 104a of the lower magnetic body 104 for forming or connecting with electrodes, in order to establish I/O current path for the first coil 106 and the second coil 108.

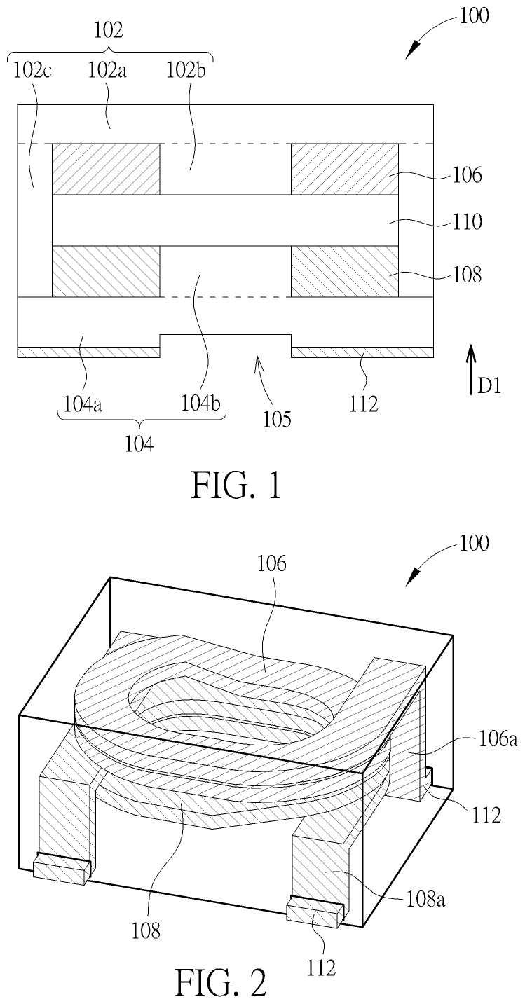

Please refer to FIG. 2, which is a schematic isometric view of the coupled inductor 100 in accordance with the embodiment of the present disclosure. Please note that this figure shows only the components of first coil 106 and second coil 108 in the coupled inductor 100 in order to provide a clear, perspective view for reader. It can be seen in the figure that the first coil 106 and the second coil 108 may include at least one winding turn of conductive wire, and are further provided with extending parts 106a and extending parts 108a extending in the vertical direction D1 to a side of the coupled inductor 100 to form or connect with electrodes 112, in order to establish I/O current path for the first coil 106 and the second coil 108. In FIG. 2, the first coil 106 may have two extending parts 106a extending in the vertical direction D1 to a first side, and the second coil 108 may have two extending parts 108a extending in the vertical direction to a second side, wherein the first side may be opposite to the second side. Please note that the electrodes 112 in the present disclosure are not limited to be on specific surfaces or positions of the coupled inductor 100. In FIG. 1, the electrodes 112 is connected with the bottom surface of the second magnetic body 104. They may be formed or set on opposite surfaces or difference surfaces of the coupled inductor 100 depending on product requirement. Besides, the entire inductor may be mounted in or on a thermal dissipating housing or plate (not shown) to improve heat dissipating effectiveness.

Refer back to FIG. 1. In the embodiment of the present disclosure, the magnetic body, including the first magnetic body 102, the gap magnetic body 110 and the second magnetic body 104, may be formed of magnetic material like ferrite, primarily containing iron (Fe) oxides combined with nickel (Ni), zinc (Zn), and/or manganese (Mn) compounds. These magnetic materials may be filled in molds in the form of mixing magnetic powder and resin binder together with the prepared first coil 106 and second coil 108. All of these components will be hot-pressed compactly to form the final solidified, molded inductor product. In other embodiment of the present disclosure, the upper magnetic body 102 and/or the lower magnetic body 104 may be molded in advance to form a solid core body, which may function as molds themselves in a hot-pressing process. The coils 106, 108 will be mounted on these pre-molded magnetic bodies 102 and/or 104 with prepared magnetic powder mixture filled therebetween for forming the gap magnetic body 110. No matter in which case, the gap magnetic body 110 in the present disclosure is formed of soft magnetic powder glue or mixture, thus it is difficult to form the gap magnetic body 110 with precise dimension between the two coils 106, 108 in the center of molds after the hot-pressing and sintering process. The gap magnetic body 100 formed after the hot-pressing usually suffer more or less deformation, which means its thickness distribution in the vertical direction D1 will be quite wide and inconsistent, unable to meet strict requirement of coupling coefficient K in 5G wireless system and automotive electronics application.

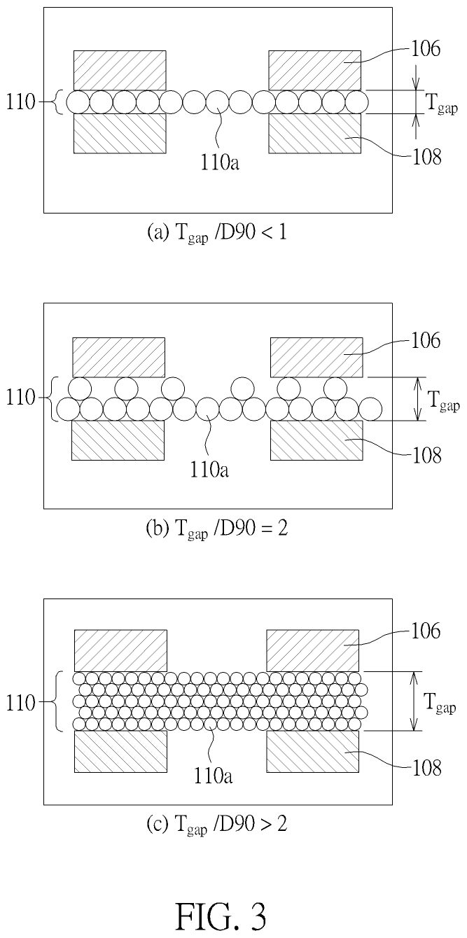

In order to solve the aforementioned problem of inconsistent thickness of the gap magnetic body 110 after the hot-pressing process, the present disclosure provides a specification for the dimension of gap magnetic body 110. Please refer to FIG. 3, which is a schematic cross-sectional view illustrating examples of coupled inductors with different ratios of the thickness of gap magnetic body to the mean particle size of gap magnetic body. Please note that for concise and clear disclosure of the essential features in the present disclosure, only schematic two coils 106, 108 and gap magnetic body 100 in the form of magnetic powder are shown in the figure. In the example (a) of FIG. 3, the ratio of thickness T_{gap} of the gap magnetic body 110 to mean particle size D90 of the gap magnetic body 110 is less than 1 (T_{gap}/D90<1). The term mean particle size D90 is a well-known, defined percentile value that can be read directly from the statistical parameters of cumulative particle size distribution. It indicates the size below which 90% of all particles are found in the gap magnetic body 110. With respect to example (a), there will be less than two magnetic particles stack in gap magnetic body, which means the deviation of thickness T_{gap} of gap magnetic body 110 after the hot-pressing may be significantly reduced due to the fixed thickness.

Refer still to FIG. 3. With respect to example (b), the ratio of thickness Tgap of the gap magnetic body 110 to mean particle size D90 of the gap magnetic body 110 is equal to 2 (T_{gap}/D90=2), meaning the thickness Tgap of gap magnetic body 110 may be two times the size of most magnetic particles 110a in the gap magnetic body 110. Under this circumstance, there will be normally two magnetic particles 110a filled in the gap between the first coil 106 and the second coil 108. However, in the situation that the ratio T_{gap}/D90 is between 1 and 2 (ex. 1<T_{gap}/D90<2), it becomes more difficult to control the uniformity of thickness T_{gap} of the gap magnetic body 110, since the gap between the two coils can't be fixed by single-layered magnetic particle 110a like in example (a), and it is not large enough to be fitted by two-layered magnetic particles 110a that may help to fix its thickness. The thickness T_{gap} of gap magnetic body 110 in this case would be quite inconsistent after the hot-pressing process and cause large deviation of resulting coupling coefficient K in final product.

Refer still to FIG. 3. With respect to example (c), the ratio of thickness T_{gap} of the gap magnetic body 110 to mean particle size D90 of the gap magnetic body 110 may be greater than 2 (T_{gap}/D90>2), meaning there would be at least two layers of the magnetic particles 110a fitted in the gap between the first coil 106 and second coil 108. Under this circumstance, the thickness T_{gap} of gap magnetic body 110 may be quite uniform after the hot-pressing process, since multilayered magnetic particles may be moved freely in the hot-pressing process to fit the predetermined thickness required by the device, in comparison to the example (b) above.

According to the aforementioned embodiment, a range of the ratio of thickness T_{gap} of the gap magnetic body 110 to mean particle size D90 of the gap magnetic body 110 in the present disclosure may be between 2-30 or between 0-0.75, on the basic of the aforementioned example (c) and example (a), respectively. This ratio range shows minimum thickness deviation of the gap magnetic body 110 after hot-pressing process based on lots of experimental results.

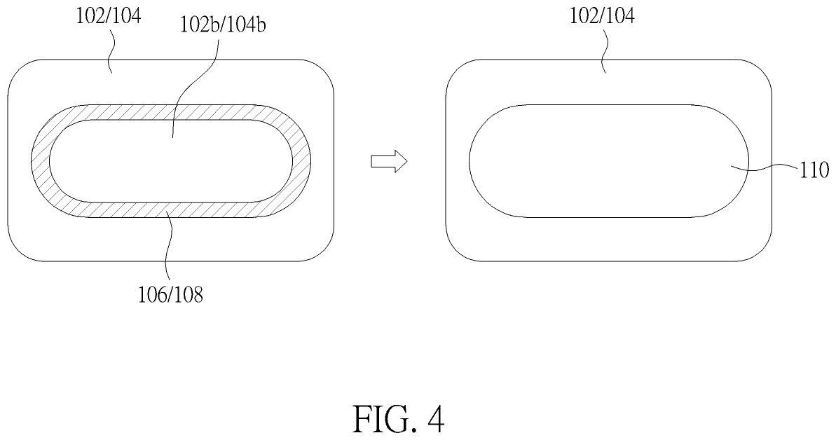

Please refer now to FIG. 4, which is a schematic plan view illustrating the coil and the gap magnetic body of coupled inductor in accordance with the embodiment of the present disclosure. In the present disclosure, the coils 106, 108 are substantially wounded around the center of magnetic body 102, 104, with the gap magnetic body 110 formed thereon to fix the height of the coils 106, 108 in the coupled inductor. The gap magnetic body 110 is required to overlap the coils 102, 104 and the central pillars 102b, 104b partly or completely in vertical direction D1, in order to separate the two coils and the two pillars and fix the height of coils. In the present disclosure, the horizontal area of gap magnetic body 110 may also influence the inductance of coupled inductor. If the area of gap magnetic body 110 is too large with respect to the area of the magnetic body 102, 104, it may become more difficult to mold the gap magnetic body 110 in the coupled inductor. On the other hand, if the area of gap magnetic body 110 is too small with respect to the area of magnetic body 102, 104, the resulting inductance may not reach predetermined target value required by the device. Based on lots of experimental results, the ratio of the area of gap magnetic body 110 to the area of magnetic body 102, 104 may be between 60%-85%. In this ratio range, the gap magnetic body 110 may be well molded in the coupled inductor and predetermined inductance may also be reached without compromise. Furthermore, since the powder of gap magnetic body 110 has lower magnetic permeability in comparison to the ones of upper and lower magnetic bodies, horizontal outer edges of the gap magnetic body 110 may not extend beyond horizontal outer edges of the coils 106, 108, or magnetic flux near sidewalls of the magnetic body may be blocked by the gap magnetic body 110, causing the reduction of inductance.

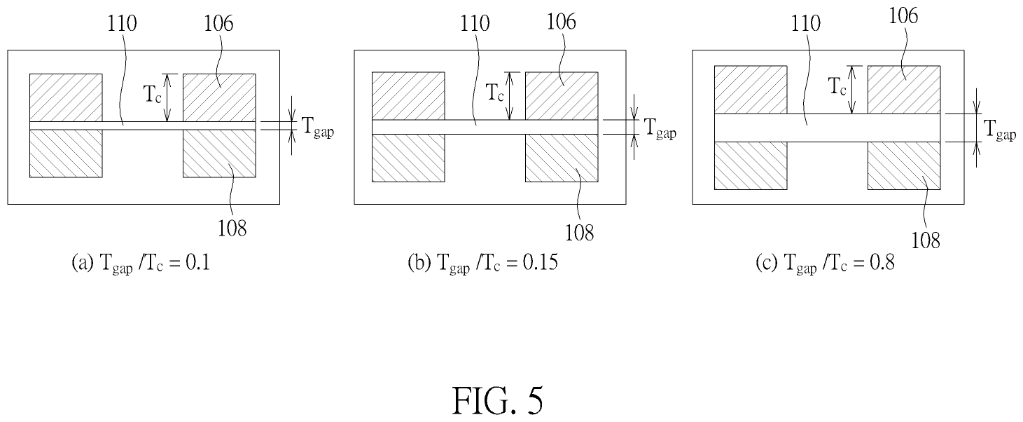

Please refer now to 5, FIG. which is a schematic cross-sectional view illustrating examples of coupled inductors with different thickness ratios of the coil to the gap magnetic body. Similar to the embodiment of FIG. 3, only schematic two coils 106, 108 and a gap magnetic body 110 are shown in the figure for concise and clear disclosure of the essential features in the present disclosure. In the present disclosure, the thickness ratio of the coils 106, 108 to the gap magnetic body 110 may also influence the inductance performance of coupled inductor. With respect to example (a) of FIG. 5, the ratio of thickness T_{gap} of the gap magnetic body 110 to the thickness T. of coils 106, 108 may be equal to 0.1 (T_{gap}/T_{c}=0.1). When the ratio is less than 0.1, it is disadvantageous to the flow of magnetic flux around the magnetic bodies and the inductance performance may be significantly degraded. With respect to example (b), the ratio of thickness T_{gap} of the gap magnetic body 110 to the thickness of coils 106, 108 may be equal to 0.15 (T_{gap}/T=0.15). This is a moderate ratio that the magnetic flux induced by the coils 106, 108 may flow normally around the magnetic bodies without hindrance. With respect to example (c), the ratio of thickness T_{gap} of the gap magnetic body 110 to the thickness of coils 106, 108 may be equal to 0.8 (T_{gap}/T_{c}=0.8). This ratio scale may cause the coupling coefficient K exceeding over the predetermined value since the thickness T_{gap} of gap magnetic body 110 is excessive.

According to the aforementioned embodiment, a range of the ratio of thickness T_{gap} of the gap magnetic body 110 to the thickness of coils 106, 108 may be between 0.15-0.8 in the present disclosure, on the basic of the aforementioned examples (b) and (c). The ratio range shows the coupling coefficient K properly meet the predetermined value, based on lots of experimental results.

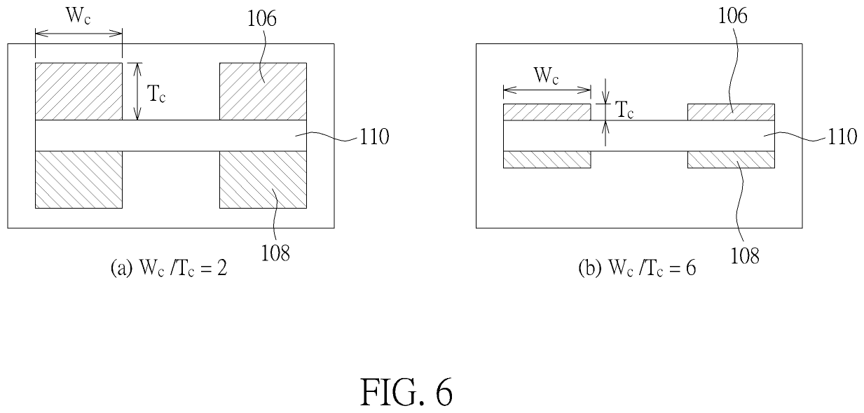

Please refer now to FIG. 6, which is a schematic cross-sectional view illustrating examples of coupled inductor with different width-to-thickness ratio of the coil. In the present disclosure, the width-to-thickness ratios of the coils may also influence the inductance performance of coupled inductor. With respect to example (a) of FIG. 6, the ratio of width W_{c} to thickness T. of the coils 106, 108 may be equal to 2 (W_{c}/T_{c}=2). When the ratio is less than 2, the induced coupling coefficient K may exceed over the predetermined value due to excessive induced magnetic flux. With respect to example (b), the ratio of width W_{c} to thickness T. of the coils 106, 108 may be equal to 6 (W_{c}/T_{c}=6). When the ratio is greater than 6, the induced coupling coefficient K may be far below the predetermined value due to insufficient induced magnetic flux.

According to the aforementioned embodiment, a range of width-to-thickness ratio of the coils 106, 108 may be between 2-6 in the present disclosure, on the basic of the aforementioned examples (a) and (b). The ratio range shows the coupling coefficient K properly meets the predetermined value, based on lots of experimental results.

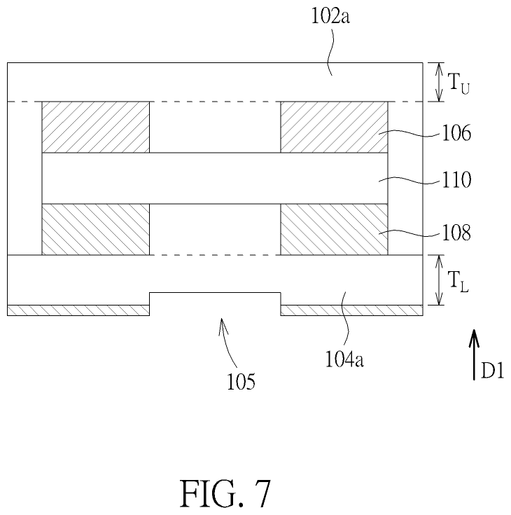

Please refer now to FIG. 7, which is a schematic cross-sectional view of a coupled inductor illustrating the upper magnetic body and lower magnetic body having different thicknesses. In the present disclosure, the thickness of upper magnetic body 106 and lower magnetic body 108 may also influence the inductance performance of coupled inductor. Please note that the thickness of magnetic body defined herein is the thickness T_{U}, T_{L} of base part 102a, 104a of the upper magnetic body and lower magnetic body in the vertical direction D1. In the present disclosure, since a recess 105 is formed on the bottom of the base part 104a of lower magnetic body, the magnetic flux in lower magnetic body may be hindered considerably by the recess 105. Thus, it may make the thickness T_{L} of lower magnetic body larger than the thickness T_{U} of upper magnetic body, in order to balance the inductance difference of upper and lower magnetic bodies. Based on lots of experimental results, a range of the ratio of the thickness T_{U} of upper magnetic body to the thickness T_{L} of lower magnetic body may be between 0.5-1 in the present disclosure. The ratio range shows the inductance of lower magnetic body is well-balanced with the inductance of upper magnetic body.

According to the aforementioned embodiments, the present disclosure develops the dimension specification for the internal components in coupled inductor, including the ratio of thickness of gap magnetic body to the mean particle size of gap magnetic body, the ratio of the horizontal area of gap magnetic body to the horizontal area of upper/lower magnetic bodies, the thickness ratio of coils to gap magnetic body, the width-to-thickness ratio of coils, and the thickness ratio of upper magnetic body to lower magnetic body. This specification may significantly lower the deviation of coupling coefficient and precisely meet the predetermined inductance required by the coupled inductor, which is suitable for the application like multi-phase DC-to-DC converter or power inductor in the field of 5G wireless system, automotive electronics, TV or HDD.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coupled inductor, comprising:
a first coil wound around a first pillar;
a second coil wound around a second pillar;
a gap magnetic body between said first coil and said second coil and comprised of magnetic powders;
a first magnetic body on said first coil opposite to said gap magnetic body; and
a second magnetic body on said second coil opposite to said gap magnetic body;
wherein said first magnetic body, said first coil, said gap magnetic body, said second coil and said second magnetic body are stacked sequentially in a first direction, and a ratio of a thickness of said gap magnetic body in said first direction to mean particle size D90 of said magnetic powders in said gap magnetic body is between 2-30 or between 0-0.75.

2. The coupled inductor of claim 1, wherein said gap magnetic body overlaps said first coil and said first pillar and overlaps said second coil and said second pillar in said first direction of said first coil and said second coil, and a ratio of an area of said gap magnetic body in said first direction to an area of said first magnetic body is between 60%-85%.

3. The coupled inductor of claim 2, wherein outer edges of said gap magnetic body is not extended beyond outer edges of said first coil and said second coil in outward directions perpendicular to said first direction.

4. The coupled inductor of claim 1, wherein a ratio of a thickness of said gap magnetic body in said first direction to a thickness of said first coil in said first direction is between 0.15-0.8.

5. The coupled inductor of claim 1, wherein a width of said first coil in a second direction perpendicular to said first direction to a thickness of said first coil in said first direction is between 2-6.

6. The coupled inductor of claim 1, wherein a thickness of said first magnetic body in said first direction to a thickness of said second magnetic body in said first direction is between 0.5-1.

7. The coupled inductor of claim 6, wherein a recess is formed on an outer surface of said second magnetic body in said first direction, and an electrode is connected with said outer surface of said second magnetic body.

8. The coupled inductor of claim 1, wherein said first coil has a first extending part extending to a first side of said coupled inductor, and said second coil has a second extending part extending to a second side of said coupled inductor.

9. The coupled inductor of claim 1, wherein said first coil has two first extending parts extending in said first direction to a first side of said coupled inductor, and said second coil has two second extending parts extending in said first direction to a second side of said coupled inductor.

10. The coupled inductor of claim 9, wherein said first side is opposite to said second side.

11. A coupled inductor, comprising:
a first coil wound around a first pillar;
a second coil wound around a second pillar;
a gap magnetic body between said first coil and said second coil and comprised of magnetic powders;
a first magnetic body on said first coil opposite to said gap magnetic body; and
a second magnetic body on said second coil opposite to said gap magnetic body;
wherein said first magnetic body, said first coil, said gap magnetic body, said second coil and said second magnetic body are stacked sequentially in a first direction, and said gap magnetic body overlaps said first coil and said first pillar and overlaps said second coil and said second pillar in said first direction of said first coil and said second coil, and a ratio of an area of said gap magnetic body in said first direction to an area of said first magnetic body is between 60%-85%.

12. The coupled inductor of claim 11, wherein outer edges of said gap magnetic body don't extend beyond outer edges of said first coil and said second coil in outward directions perpendicular to said first direction.

13. The coupled inductor of claim 11, wherein a ratio of a thickness of said gap magnetic body in said first direction to mean particle size D90 of said magnetic powders in said gap magnetic body is between 2-30 or between 0-0.75.

14. The coupled inductor of claim 11, wherein a ratio of a thickness of said gap magnetic body in said first direction to a thickness of said first coil in said first direction is between 0.15-0.8.

15. The coupled inductor of claim 11, wherein a width of said first coil in a second direction perpendicular to said first direction to a thickness of said first coil in said first direction is between 2-6.

16. The coupled inductor of claim 11, wherein a thickness of said first magnetic body in said first direction to a thickness of said second magnetic body in said first direction is between 0.5-1.

17. The coupled inductor of claim 16, wherein a recess is formed on an outer surface of said second magnetic body in said first direction, and an electrode is connected with said outer surface of said second magnetic body.

18. The coupled inductor of claim 11, wherein said first coil has a first extending part extending in said first direction to a first side of said coupled inductor, and said second coil has a second extending part extending in said first direction to a second side of said coupled inductor.

19. The coupled inductor of claim 11, wherein said first coil has two first extending parts extending in said first direction to a first side of said coupled inductor, and said second coil has two second extending parts extending in said first direction to a second side of said coupled inductor.

20. The coupled inductor of claim 19, wherein said first side is opposite to said second side.
